(19) United States
(12) Patent Application Publication
(10) Pub. No.: US 2006/0155879 A1
(43) Pub. Date: Jul. 13, 2006

(54) [METHOD FOR RECEIVING DATA BY A UNIVERSAL ASYNCHRONOUS RECEIVER TRANSMITTER]

(75) Inventor: Pi-Yuan Shih, TAIPEI (TW)

Correspondence Address: MOXA TECHNOLOGIES CO., LTD, P.O. BOX 108-00403, TAIPEI, TW

(73) Assignee: MOXA TECHNOLOGIES CO., LTD., Shing Tien City, Taipei Hsien (TW)

(21) Appl. No.: 10/905,536

(22) Filed: Jan. 9, 2005

(51) Int. Cl. G06F 3/00

(52) U.S. Cl. 710/1

(57) ABSTRACT

The present invention discloses a method for receiving data by a universal asynchronous receiver transmitter and the universal asynchronous receiver transmitter includes a receive shift register and a counter, and the receive shift register is connected to a receive register, and the receive register is connected to a preinstalled microprocessor through a bus, such that when the receive shift register receives a plurality of serial data, the counter counts the correct data marked by an error bit, and the microprocessor bases on the count of the counter as the number of times for reading data addresses to read all data marked as a correct data and enhances the performance of reading data.

### BACKGROUND OF THE INVENTION

1. Field of the Invention

The present invention relates to a method for receiving data by a universal asynchronous receiver transmitter, more particularly a method for receiving data by using a counter installed in a universal asynchronous receiver transmitter to count the number of correct data as to enhance the performance of reading data.

2. Description of Related Art

As communication originally refers to the communication of ideas or the exchange of information, but communication nowadays also includes a wireless or a cable transmission of multimedia information such as sound, image and text to a remote end. From the technical definition of communication, various signals can be sent successfully, efficiently and safely to a remote place after being coded and modulated, and an “electric” transmission function is used to rapidly and conveniently view a television program, make a phone call, listen to a radio broadcast, transmit a document as well as using a wireless or cable modem to send or receive emails through the Internet, browse a webpage and use an Internet phone, etc through the network.

At present, networking has become the second largest medium, which is an indispensable information source to most people and an important channel for the communication between people. If a network transmission is considered as a highway, then every user must have an exit analog to a receiver transmitter for sending or receiving information distributed on the highway. As the transmitting speed is increasing constantly, the receiver transmitter must come with a fast operating speed as well. Now, the most popular receiver transmitter is the universal asynchronous receiver transmitter (UART) which is also known as the serial communication interface (SCI). This kind of universal asynchronous receiver transmitter is a serial interface RS-232 installed in an electronic product such as a general instrument, a computer or a PDA and it is the current mainstream of serial transmissions.

Please refer to FIGS. 1 to 7 for the schematic views of the process of reading data by a traditional universal asynchronous receiver transmitter. In the figures, when the universal asynchronous receiver transmitter A receives a serial data, the serial data is saved in a receive shift register (RSR) A1, and the receive shift register A1 also saves the start bit, end bit and data bits of each record of the serial data into the receive shift register A1. However, since the receive shift register A1 has no mapping for the memory address, therefore the data of the receive shift register A1 cannot be accessed directly. After the receive shift register A1 has received an end bit, a data bit section in the receive shift register A1 will be shifted to a data address A21 of a receive register A2. In the process of receiving a serial data, an end bit should be received after all data bits are received. If an end bit is not received at that time, a frame error will occur. Further, if a parity check mechanism is enabled and the received parity bit is incorrect, then a parity error will be generated, and the parity bit in an error bit A22 of the receive register A2 corresponding to the data address A21 is set as an error. If an end bit is received after all data bits are received, then the error bit A22 corresponding to the data address A21 of the receive register A2 is set as correct, such that when a microprocessor B reads a serial data in the receive register A2 through a bus C, each record of data will be read twice sequentially, wherein the first time is to read the error bit A22 and check whether the data is marked as correct or an error, and the second time is to read the data stored in the data address A21 and retrieve the serial data stored in the receive register A2. The error bit A22 is used to determine whether or not this record of data is correct. If the error bit A22 of the read data is set as an error, then the microprocessor B must be able to process this record of data. In this example, six serial data stored in the receive register A2 are read according to the aforementioned method, the microprocessor B will read the receive register A2 for 12 times.

However, when the foregoing prior-art universal asynchronous receiver transmitter A is receiving data, it is necessary to read every record of data twice before retrieving the data, and such process increases the workload of the microprocessor B and lowers its performance. The current electronic products emphasize on an all-in-one design, and the microprocessor B will be unable to process other work with a high performance or the processing speed will become very slow. Such prior art definitely causes inconvenience to users.

Therefore, it is desirable to provide a memory card connector that eliminates the aforesaid drawbacks.

### SUMMARY OF THE INVENTION

Therefore, it is a primary objective of the present invention to use a counter installed in a universal asynchronous receiver transmitter, such that when a receive register receives a serial data sent from a receive shift register, the counter counts the number of correct data marked in an error bit, and the microprocessor bases on the count of the counter as the number of times for reading the data addresses to read all data stored in the data address corresponding to the error bit marked as correct in order to enhance the performance of reading data.

### BRIEF DESCRIPTION OF THE DRAWINGS

FIG. 1 is a first schematic view of the process of reading data by a prior-art universal asynchronous receiver transmitter.

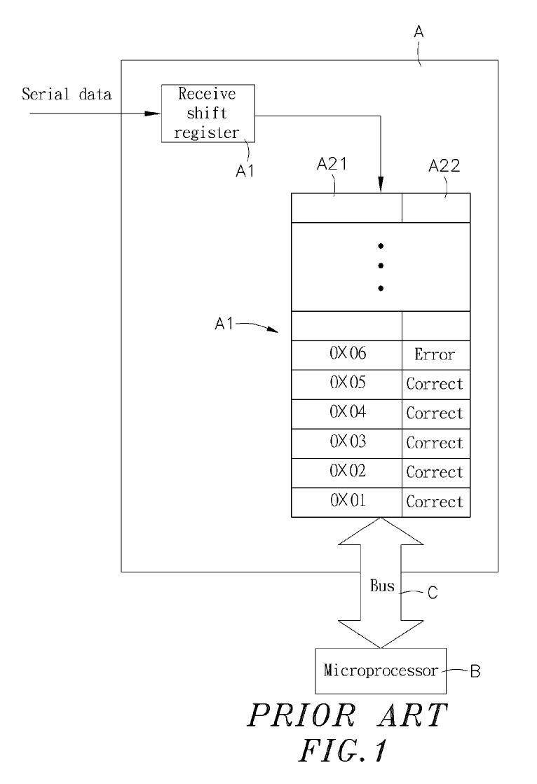

FIG. 2 is a second schematic view of the process of reading data by a prior-art universal asynchronous receiver transmitter.

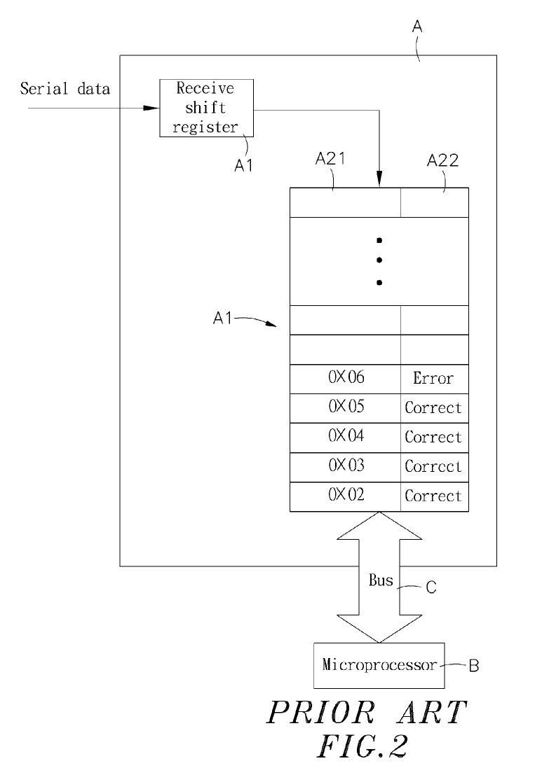

FIG. 3 is a third schematic view of the process of reading data by a prior-art universal asynchronous receiver transmitter.

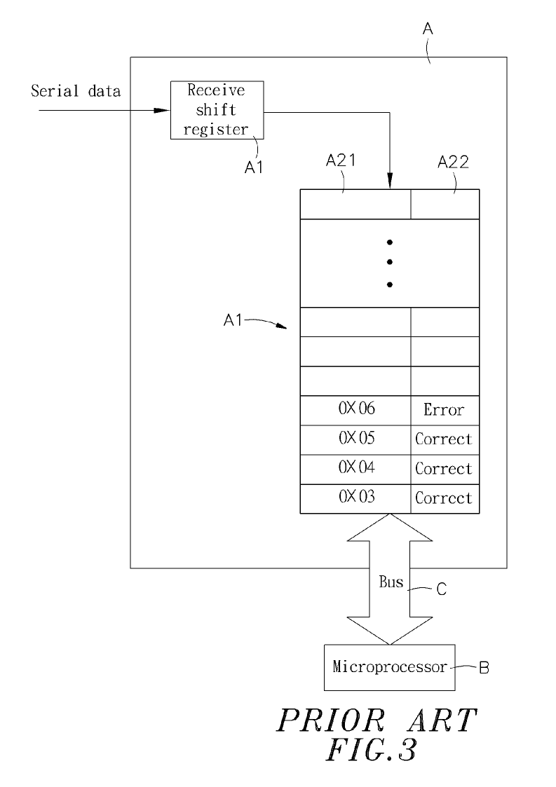

FIG. 4 is a fourth schematic view of the process of reading data by a prior-art universal asynchronous receiver transmitter.

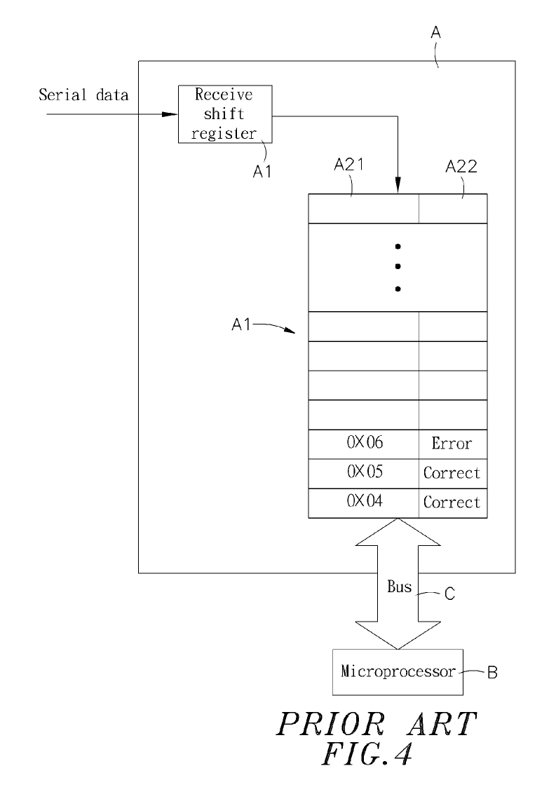

FIG. 5 is a fifth schematic view of the process of reading data by a prior-art universal asynchronous receiver transmitter.

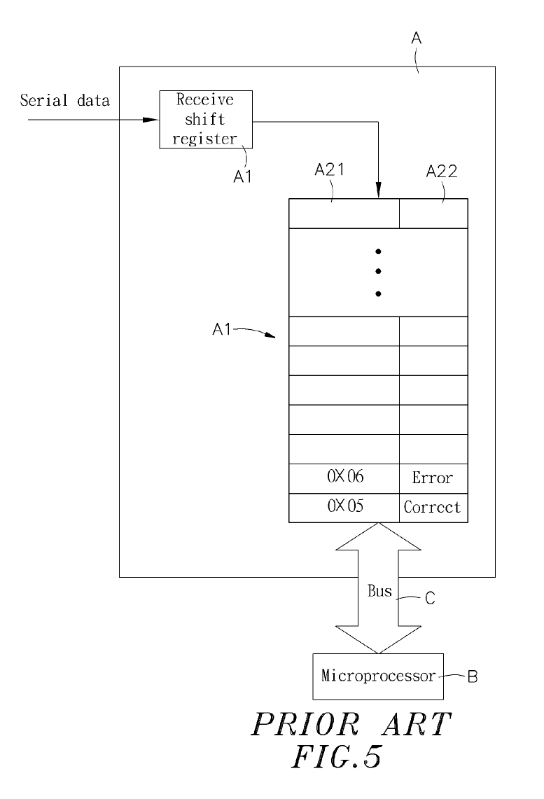

FIG. 6 is a sixth schematic view of the process of reading data by a prior-art universal asynchronous receiver transmitter.

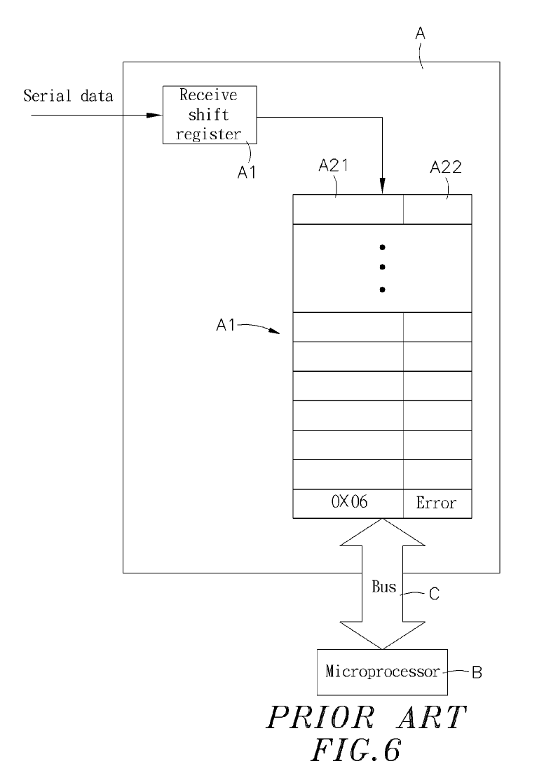

FIG. 7 is a seventh schematic view of the process of reading data by a prior-art universal asynchronous receiver transmitter.

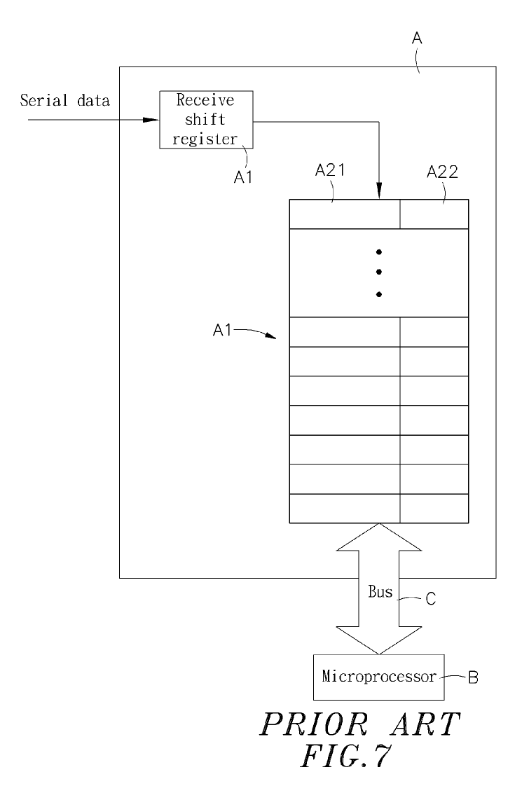

FIG. 8 is a first schematic view of the process for reading data by a universal asynchronous receiver transmitter according to the present invention.

FIG. 9 is a second schematic view of the process for reading data by a universal asynchronous receiver transmitter according to the present invention.

FIG. 10 is a third schematic view of the process for reading data by a universal asynchronous receiver transmitter according to the present invention.

### DETAILED DESCRIPTION OF THE EMBODIMENTS

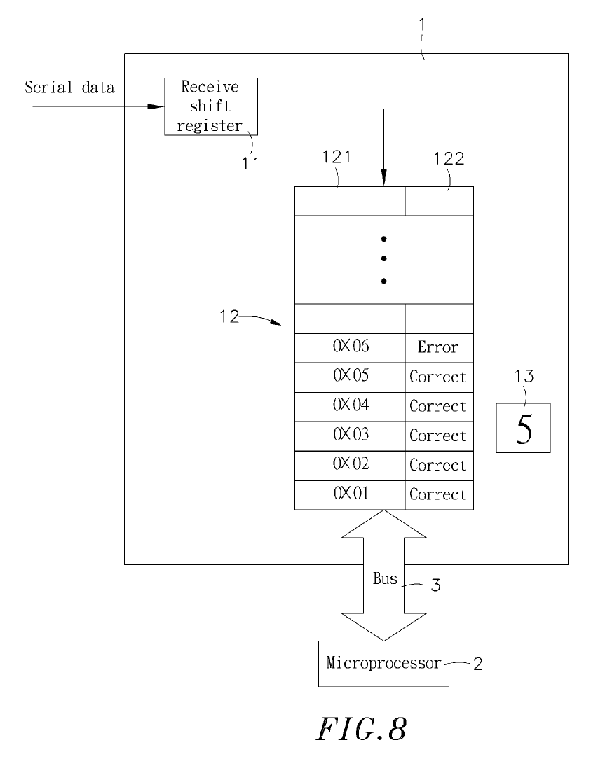

Please refer to FIG. 8 for the first schematic view of the process for reading data by a universal asynchronous receiver transmitter according to the present invention. In FIG. 8, a universal asynchronous receiver transmitter 1 comprises a receive shift register 11, a receive register 12 and a counter 13.

The receive shift register 11 can receive a serial data, and the serial data includes a start bit, an end bit and a data bit, and the serial data can be sent to the receive register 12.

The receive register 12 can store a serial data transmitted from the receive shift register 11, and the receive register 12 is coupled to a microprocessor 2 through a bus 3, and the receive register 12 comprises a data address 121 and its corresponding error bit 122, and the data address 12 can store the data bit section of the serial data, and the error bit 122 can be set as correct or error for the data stored in the corresponding data address 121.

The counter 13 counts the number of data marked as a correct data by the error bit 122 when the receive register 12 receives a serial data transmitted from the receive shift register 11.

When the universal asynchronous receiver transmitter 1 receives a serial data through the receive shift register 11, the start bit, end bit and data bit of each record of serial data will be stored in the receive shift register 11; and after the receive shift register 11 has received an end bit, the data bit section in the receive shift register 11 will be transmitted into the data address 121 of the receive register 12. During the process of receiving the serial data, an end bit should be received after all data bits have been received. If an end bit is not received at that time, then a frame error will occur; or if a parity check mechanism is enabled and the received parity bit is an error, then a parity error will occur, and the parity bit in the error bit 122 of the receive register 12 corresponding to data address 121 is set as an error. After all data bits are received, an end bit is received and thus the error bit 122 of the receive register 12 corresponding to the data address 121 of such record of data is set as correct.

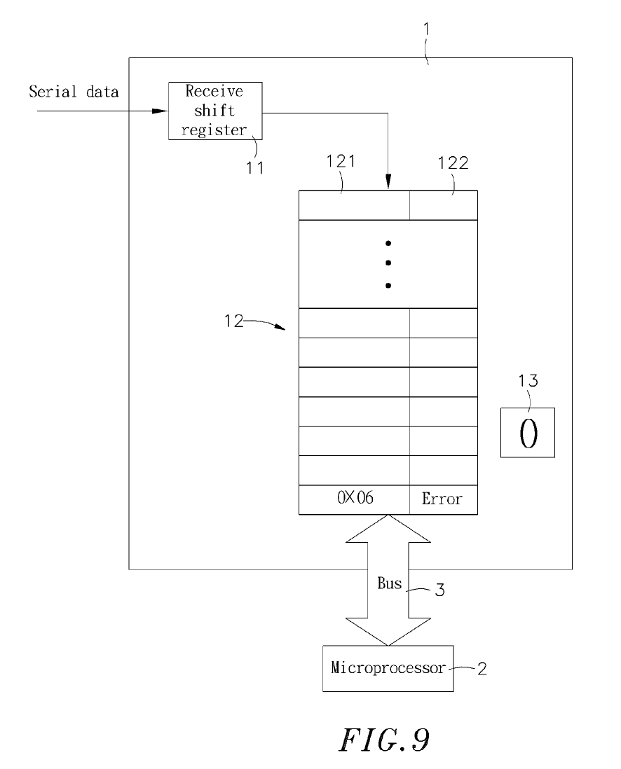

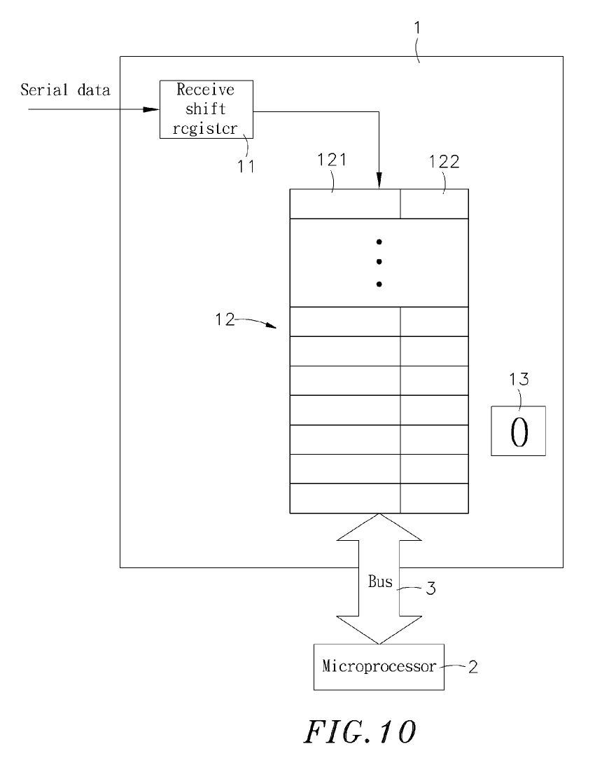

Please refer to FIGS. 8, 9 and 10 for the schematic views of the process for reading data by a universal asynchronous receiver transmitter according to the present invention. In the figures, when the receive register 12 receives a data transmitted from the receive shift register 11, the counter 13 continues counting the number of data marked as a correct data in the error bit 122 of the receive register 12 until an error marked by the error bit 122 shows up. When the counter 13 stops counting, the microprocessor 2 will obtain the count of the counter 13 through the bus 3, and such count is used to determine the number of times for reading the data address 121. Since the number of records of data marked as correct by the error bit 122 is counted by the counter 13, the microprocessor 2 no longer needs to read the error bit 122 for a second time, but it only needs to read the data address 121 for the number of times according to the count of the counter 13 as to read all data stored in the data address 121 corresponding to the error bit 122 marked as correct, and then the microprocessor 2 reads the data address 121 for a second time before retrieving the data stored in the data address 121 corresponding to the error bit 122 marked as an error.

In view of the description above, the six records of data stored in the receive register 12 are read according to the foregoing preferred embodiment, and the microprocessor 2 only needs to read the universal asynchronous receiver transmitter 1 for eight times. Compared with the prior art that reads the same quantity of data in the same condition for 12 times, the present invention enhances the performance of reading data as well as the performance of the microprocessor 2.

Therefore, the method for receiving data by a universal asynchronous receiver transmitter in accordance with the present invention emphasizes its claim on adopting a counter 13 installed in the universal asynchronous receiver transmitter 1 for counting the number of data marked as correct by an error bit 122, such that a microprocessor 2 only needs to read a data address 121 for the number of times according to the count of a counter 13 as to read all data stored in the data address 121 marked as correct by the error bit 122, and thus enhancing the performance of reading data. However, the sequence of arranging the data addresses 121 according to the preferred embodiments is given for the simplicity to make the description easier for our examiner to understand. In actual operations, the data addresses 121 may be discontinuously or randomly located, but it will not affect the implementation of the present invention.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. A method for receiving data by a universal asynchronous receiver transmitter, and said universal asynchronous receiver transmitter being a receive shift register for receiving a plurality of serial data, and said receive shift register being coupled to a receive register capable of storing a serial data transmitted from said receive shift register, and said receive register being coupled to a preinstalled microprocessor through a bus, and a data address and its corresponding error bit being disposed in said receive register, and said data address being capable of storing the data bit section of said serial data, and said error bit being set for determining a correct storage of said serial data in said corresponding data address; characterized in that said universal asynchronous receiver transmitter comprises a counter for counting the number of correct data indicated by computing a error bit, such that said microprocessor bases on the count accumulated by said counter as the number of times for said microprocessor to read data as to read all data stored in said data address corresponding to an error bit marked as a correct data and improve the performance of reading data.

2. The method of receiving data by a universal asynchronous receiver transmitter according to claim 1, wherein said counter stops counting when an error bit marked as an error occurs.
